(19) United States
(12) Patent Application Publication
(10) Pub. No.: US 2009/0311600 A1
(43) Pub. Date: Dec. 17, 2009

(54) NEGATIVE ELECTRODE FOR NONAQUEOUS ELECTROLYTE SECONDARY BATTERY, NONAQUEOUS ELECTROLYTE SECONDARY BATTERY INCLUDING THE SAME AND METHOD FOR FABRICATION OF NEGATIVE ELECTRODE FOR NONAQUEOUS ELECTROLYTE SECONDARY BATTERY

(75) Inventors: Hiroshi Minami, Kobe-city (JP); Naoki Imachi, Kobe-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/481,940

(22) Filed: Jun. 10, 2009

(30) Foreign Application Priority Data
Jun. 13, 2008 (JP) 2008-154932

(51) Int. Cl. H01M 4/62; H01M 4/82

(52) U.S. Cl. 429/217; 29/623.5

(57) ABSTRACT

Provided are a negative electrode for a nonaqueous electrolyte secondary battery, which has a current collector and a mix layer strongly adhered to each other and can increase a capacity of a nonaqueous electrolyte secondary battery, a fabrication method of the negative electrode and a nonaqueous electrolyte secondary battery including the negative electrode.

The negative electrode for a nonaqueous electrolyte secondary battery includes a current collector and a mix layer provided on the current collector. The mix layer contains polyvinyl pyrrolidone having a K value in the range of 34˜112, carboxymethylcellulose, a latex binder and a negative active material. The carboxymethylcellulose is contained in a higher weight concentration than the polyvinyl pyrrolidone.

### BACKGROUND OF THE INVENTION

1. Field of Invention

The present invention relates to a negative electrode for a nonaqueous electrolyte secondary battery, a nonaqueous electrolyte secondary battery including the negative electrode, and a method for fabrication of the negative electrode for a nonaqueous electrolyte secondary battery.

### 2. Description of Related Art

With the recent rapid progress of reduction in size and weight of mobile information terminals such as mobile telephones, notebook personal computers and PDA (Personal Data Assistant), a need is increasing for further capacity improvement of a battery for use as a driving power source. Also, application of a nonaqueous electrolyte secondary battery for uses where a high power is required, such as an HEV (Hybrid Electric Vehicle) and power tools, has been pushed forward. Thus, the development of a nonaqueous electrolyte secondary battery is being directed to two objects; capacity improvement and power increase.

As to the capacity improvement, a high-capacity positive electrode material as an alternative of lithium cobaltate, as well as a high-capacity negative electrode material as an alternative of graphite, have been investigated. However, positive and negative electrodes using lithium cobaltate and graphite, which are leading materials for current lithium secondary batteries, exhibit well-balanced performances. In addition, various mobile devices have been designed to adapt their operation for the characteristics of batteries using these materials. These have led to the current state in which the development of high-capacity electrode materials substituting for lithium cobaltate and graphite is little furthered. A negative electrode material, in particular, shows a significant change of a charge/discharge curve when its type is altered. This largely changes a working voltage of a battery. Under such circumstances, it is difficult to further substitution of graphite with the other high-capacity negative electrode materials.

However, in the current circumstances where a capacity increase of batteries is strongly demanded as a yearly power consumption of mobile devices is increasing steadily, it may be forced to accommodate a growing demand for the capacity increase, for example, by increasing a charge density of a negative electrode using graphite or by increasing a thickness of a mix layer.

Meanwhile, in recent years, the use of an aqueous slurry in the fabrication of a negative electrode has been proposed, for example, from a viewpoint of reducing environmental load in the manufacture of nonaqueous electrolyte secondary batteries. An aqueous slurry using a latex binder such as styrene-butadiene rubber (SBR) is known as useful for fabrication of a negative electrode. However, such aqueous slurry using a latex binder is difficult to achieve thick-film coating. Accordingly, a thickener such as carboxymethylcellulose (CMC) is generally added to the aqueous slurry using a latex binder, as disclosed in Japanese Patent Laid-open No. 2002-175807, for example.

The aqueous slurry using CMC and a latex binder exhibits superior coatability and use thereof eases thick-film coating. Accordingly, a thick mix layer can be formed by a single coating operation of the aqueous slurry.

However, the use of the aqueous slurry using CMC and a latex binder results in the difficulty to obtain high bond strength between a current collector and the mix layer, which is a problem.

As will be described later, the negative electrode for a nonaqueous electrolyte secondary battery, in accordance with the present invention, has a mix layer which contains a specific type of polyvinyl pyrrolidone (PVP), CMC, a latex binder and a negative electrode active material and in which CMC is contained in a larger amount by weight than PVP. However, in Japanese Patent Laid-open Nos. 2002-175807, Hei 6-275279, Hei 10-106542, Hei 9-213306 and 2005-228679, no disclosure is provided as to the incorporation of both PVP and CMC in the mix layer, the effect obtained by such incorporation, the preferred type of PVP for incorporation in the mix layer, and the preferred CMC and PVP contents of the mix layer.

### SUMMARY OF THE INVENTION

It is an object of the present invention to provide a negative electrode for a nonaqueous electrolyte secondary battery, which has a current collector and a mix layer strongly bonded to each other and can increase a capacity of the nonaqueous electrolyte secondary battery, a fabrication method of the negative electrode and a nonaqueous electrolyte secondary battery including the negative electrode.

The negative electrode for a nonaqueous electrolyte secondary battery, in accordance with the present invention, has a current collector and a mix layer formed on the current collector. The mix layer contains polyvinyl pyrrolidone (PVP) having a K value in the range of 34-112, carboxymethylcellulose (CMC), a latex binder and a negative active material, wherein CMC is contained in the larger amount by weight than PVP and wherein the K value is given by the following equation (1):

K=(1.5 log η−1)/(0.15+0.003 c)+{300 c log η+(c+1.5 c log η)²}^{1/2}/(0.15 c+0.003 c²) (1)

where,

n=relative viscosity at 25° C. of the aqueous PVP solution to water; and

c=weight concentration of PVP in the aqueous PVP solution.

The above equation (1) is generally called a Fikentscher equation. The K value in the above equation (1) represents a degree of polymerization and is correlated to a molecular weight.

Incorporating both CMC and PVP in the mix layer, rendering the CMC content of the mix layer higher than the PVP content and maintaining the K value, given by the above equation (1) (may also be hereinafter referred to simply as the “K value”) for PVP, to fall within the range of 34-112, in accordance with the present invention, as described above, ensure both of high bond strength between the current collector and the mix layer and high dispersion stability of the negative active material in the mix layer.

The aqueous slurry (may also be hereinafter referred to as “CMC-rich aqueous CMC/PVP slurry”) containing PVP having the K value given by the above equation (1) within the range of 34-112, CMC, a latex binder and a negative active material, with CMC being contained in the larger amount by weight than PVP, is coated onto a current collector and then dried to form the mix layer of the present invention. In this case, the CMC-rich aqueous CMC/PVP aqueous slurry, because of its superior coatability and ability to achieve thick-film coating, can form a thick mix layer by a single coating operation. This accordingly achieves a capacity increase of a nonaqueous electrolyte secondary battery.

In the present invention, PVP and CMC are both used as a dispersant. For example, in the case where PVP is excluded and CMC alone is used as a dispersant, it is possible to obtain high dispersion stability of the negative active material in the mix layer but is difficult to increase bond strength between the current collector and the mix layer to a sufficiently high level. This is presumably because the low adsorbability of CMC to the negative active material increases a tendency of particles of the negative active material to leave surface portions that remain unadsorbed by CMC.

On the other hand, the case where CMC is excluded and PVP alone is used as a dispersant results not only in the failure to obtain high bond strength between the current collector and the mix layer, but also in the difficulty to obtain high dispersion stability of the negative active material in the mix layer. This is presumably because the high adsorbability of PVP to the negative active material renders a PVP molecule more prone to adsorb onto a single negative active material particle instead of adsorbing onto plural negative active material particles.

In the present invention, the CMC content of the mix layer is higher than the PVP content. If the CMC content of the mix layer is equal to or less than the PVP content, it likely becomes difficult to increase bond strength between the current collector and the mix layer.

In the case where the CMC/PVP aqueous slurry is used, if its CMC content is lower than the PVP content, it becomes more likely that coatability is lowered and thick-film coating is rendered difficult.

From the viewpoints of improving bond strength between the current collector and the mix layer and achieving a capacity increase, the ratio by weight of PVP to CMC in the mix layer preferably falls within the following range; 0/10<PVP/CMC≦4/6.

Also in the present invention, the K value of PVP contained in the mix layer is preferably not less than 34. If it is less than 34, it becomes difficult to obtain high dispersion stability of the negative active material in the mix layer.

The aqueous slurry containing PVP having a K value of less than 34 has low coatability and is difficult to achieve thick-film coating. When such aqueous slurry containing PVP having a K value of less than 34 is coated onto a current collector and dried to form a mix layer, it encounters the difficulty to form a thick mix layer by a single coating operation and thus achieve a capacity increase.

From the viewpoints of further increasing dispersion stability of the negative active material and achieving a capacity increase, the K value of PVP contained in the mix layer is preferably not less than 34, more preferably not less than 47.

In the present invention, the K value of PVP is preferably not greater than 112. If the K value of PVP contained in the CMC/PVP aqueous slurry exceeds 112, a viscosity of the CMC/PVP aqueous slurry may become too high to result in successful coating thereof. From the viewpoint of obtaining high coatability of the CMC/PVP aqueous slurry, the K value of PVP is more preferably not greater than 103.

Examples of PVP's having a K value of 34-112 include BASF Luviskol K-60 (K value: 52-62), BASF Luviskol K-80 (K value: 74-82), BASF Luviskol K-85 (K value: 83-88), BASF Luviskol K-90 in powder form (K value: 88-96), BASF Luviskol K-90 in the form of about 20% solution in water (K value: 90-103), Nippon Shokubai polyvinyl pyrrolidone K-85 (K value in powder form: 84-88, K value in the form of a solution in water: 86-90) and Nippon Shokubai polyvinyl pyrrolidone K-90 (K value in powder form: 88-96, K value in the form of a solution in water: 90-103).

In the present invention, a total amount of CMC and PVP contained in the mix layer is preferably in the range of 0.2-2.0% by weight, more preferably in the range of 0.5-1.5% by weight. Within this range, the dispersion stability of the negative active material in the mix layer tends to increase with the total amount of CMC and PVP. However, if the total amount of CMC and PVP exceeds 2.0% by weight, an efficiency at which ions are extracted from and inserted into the negative active material starts to show a declining tendency. On the other hand, if the total amount of CMC and PVP falls below 0.2% by weight, it likely becomes difficult to obtain sufficient dispersion stability of the negative active material in the mix layer.

In the present invention, the amount of the latex binder contained in the mix layer is preferably in the range of 0.5-2.0% by weight, more preferably in the range of 0.5-1.5% by weight. As the amount of the latex binder exceeds 2.0% by weight, the efficiency at which ions are extracted from and inserted into the negative active material starts to show a declining tendency. On the other hand, if the amount of the latex binder falls below 0.5% by weight, it likely becomes difficult to obtain sufficient bond strength.

In the present invention, the negative active material is not particularly specified in type, so long as it is capable of reversible storage and release of lithium. Examples of negative active materials include carbon material, tin oxide, metallic lithium and silicon, and mixtures containing two or more of them. The preferred negative active material, among them, is a carbon material from the viewpoints of electrode characteristics and cost.

Examples of carbon materials include natural graphite, artificial graphite, mesophase pitch-based carbon fibers (MCF), mesocarbon microbeads (MCMB), coke, hard carbon, fullerene and carbon nanotubes. The use of graphite such as natural graphite or artificial graphite, among them, is particularly preferred for the smaller change in potential during insertion and extraction of lithium.

In the present invention, the latex binder is not particularly specified in type. Specific examples of latex binders include styrene-butadiene rubber (SBR), acrylonitrile-butadiene rubber, acrylic ester latex, vinyl acetate latex, methyl methacrylate-butadiene latex and carboxy modifications thereof. Among them, highly Li-ion conducting SBR is preferably used as the latex binder.

The nonaqueous electrolyte secondary battery of the present invention includes the negative electrode of the present invention for a nonaqueous electrolyte secondary battery, a positive electrode and a nonaqueous electrolyte. Accordingly, the increased bond strength between the current collector and the mix layer in the negative electrode, as well as the increased capacity, can be imparted to the nonaqueous electrolyte secondary battery of the present invention.

In the present invention, the positive electrode is not particularly specified in type and can be selected from those generally used in lithium secondary batteries. The positive electrode generally includes a current collector and a mix layer deposited on the current collector and containing a positive active material. The current collector for use in the positive electrode is not particularly specified and may comprise an aluminum foil, for example.

The positive active material is not particularly specified, either. Specific examples of positive active materials include lithium cobaltate, nickel-containing lithium complex oxide, spinel type lithium manganate and olivine type lithium iron phosphate. Specific examples of nickel-containing lithium complex oxides include lithium complex oxides of Ni—Co—Mn, Ni—Mn—Al and Ni—Co—Al. These positive active materials may be used alone or in combination.

The nonaqueous electrolyte generally contains a supporting salt and a solvent. The supporting salt may or may not contain lithium. Examples of lithium-containing supporting salts include LiPF₆, LiBF₄, LiN(SO₂CF₃)₂, LiN(SO₂C₂F₅)₂ and LiPF₍₅₋ₓ₎ (CnF₍₂ₙ₊₁₎)ₓ (where, 1<x<6 and n=1 or 2). These supporting salts may be used alone or in combination.

Examples of solvents for use in the nonaqueous electrolyte include carbonate solvents such as ethylene carbonate (EC), diethylene carbonate (DEC), propylene carbonate (PC), γ-butyrolactone (CBL), ethylmethylcarbonate (EMC) and dimethyl carbonate (DMC). These carbonate solvents may be used alone or in combination. For example, the use of a mixed solvent containing a cyclic carbonate solvent and a chain carbonate solvent is preferred.

A concentration of the supporting salt in the nonaqueous electrolyte is not particularly specified, but may preferably be in the approximate range of 1.0-1.8 mol/L.

An end-of-charge voltage of the battery of the present invention is not particularly specified and may be set at about 4.2 V or greater, for example.

The method for fabrication of a negative electrode for a nonaqueous electrolyte secondary battery in accordance with the present invention is a method by which the negative electrode of the present invention can be fabricated. The method includes the steps of preparing an aqueous slurry which contains PVP having a K value in the range of 34-112 when calculated from the equation (1), CMC, a latex binder and a negative active material, with CMC being contained in the larger amount by weight than PVP, and forming a mix layer by coating the aqueous slurry onto a current collector and drying the aqueous slurry.

As described earlier, the CMC-rich aqueous CMC/PVP slurry for use in the present invention has superior coatability so that its use enables formation of a thick mix layer by a single coating operation. Accordingly, a capacity increase of a nonaqueous electrolyte secondary battery can be accomplished by using a negative electrode for a nonaqueous electrolyte secondary battery which is fabricated in accordance with the fabrication method of the present invention. Also, the use of this CMC-rich aqueous CMC/PVP slurry enhances bond strength between the current collector and the mix layer in the negative electrode.

In the step of preparing the aqueous slurry, CMC is preferably added to the negative active material before PVP. This improves coatability of the aqueous slurry and allows formation of a thicker mix layer by a single coating operation.

In accordance with the present invention, a negative electrode for a nonaqueous electrolyte secondary battery, which has high bond strength between a current collector and a mix layer and can achieve a capacity increase of a nonaqueous electrolyte secondary battery, a method for fabrication thereof and a nonaqueous electrolyte secondary battery including the negative electrode can be provided. The nonaqueous electrolyte secondary battery of the present invention is suitable for use as a power source for driving mobile information terminals such as mobile telephones, notebook personal computers and PDA, and high-output devices such as HEV and power tools.

### DESCRIPTION OF THE PREFERRED EXAMPLES

The present invention is below described in more detail by way of examples which are not intended to be limiting thereof. Suitable changes and modifications can be effected without departing from the scope of the present invention.

### Preliminary Experiment

In the following preliminary experiment, a group of negative electrode-forming aqueous slurries containing CMC as a sole dispersant was prepared to study a relationship between a solids concentration of the negative electrode-forming aqueous slurry at the time of kneading and a percentage adsorption of CMC as well as a relationship between a percentage adsorption of CMC and a bond strength between a current collector and a mix layer.

Using water as a diluting solvent, artificial graphite (mean particle diameter: 21 μm, surface area: 4.0 m²/g), CMC (manufactured by Daicel Chemical Industries, Ltd., product designation: 1380 (degree of etherification: 1.0-1.5)) and SBR at the ratio by weight of 98:1:1 were mixed in a kneader (HIVIS MIX manufactured by Primix Corp.) to prepare plural types of negative electrode-forming slurries having different solids concentrations. Specifically, CMC was first dissolved in deionized water using a mixer (ROBOMIX manufactured by Primix Corp.) to obtain an aqueous CMC solution. Subsequently, this CMC solution and graphite were mixed using a kneader (HIVIS MIX manufactured by Primix Corp.) at 90 rpm for 60 minutes, so that the solids content ratio by weight of graphite to CMC was brought to 98:1. SBR was then added to the kneader (HIVIS MIX from Primix Corp.) such that the solids content ratio by weight of graphite to CMC to SBR was brought to 98:1:1. Thereafter, the mixture was kneaded in the kneader at 40 rpm for 45 minutes to obtain a negative electrode-forming slurry having a predetermined solids concentration.

This negative electrode-forming slurry was coated on a copper foil to a target coating weight of 204 mg/10 cm², dried and then rolled to thereby form a mix layer. As a result, the negative electrodes 1-4 of preliminary experiment were obtained. As shown below in Table 1, solids concentrations of the negative electrodes 1-4 of preliminary experiment at the time of kneading were 45% by weight, 50% by weight, 55% by weight and 60% by weight, respectively.

Subsequently, bond strength between the current collector and the mix layer was measured for the negative electrodes 1-4 of preliminary experiment according to a 90 degree peel strength testing method. Specifically, each of the negative electrodes 1-4 of preliminary experiment was first adhered onto a 120 mm×30 mm acrylic plate using a 70 mm×20 mm, both-sided tape (“NICETACK NW-20” manufactured by Nichiban Co., Ltd.). One end of the adhered negative electrode was pulled 55 mm upward at a 90 degree angle relative to a surface of the mix layer at a constant speed (50 mm/min) using small-scale table testing instruments (“FGS-TV” and “FGP-5”) manufactured by Nidec-Shimpo Corporation to measure peel strength. This peel strength measurement was repeated three times and an average value of the three measurement results was reported as the 90 degree peel strength.

Meanwhile, the slurry prior to addition of SBR was withdrawn and subjected to a centrifugal treatment to obtain a supernatant liquid which was subsequently measured for viscosity using a viscometer (VIBRO VISCOMETER (model No. SV-10) manufactured by A & D Company). In addition, aqueous CMC solutions having varied concentrations were measured for viscosity using the above viscometer. The viscosity of the supernatant liquid was compared to those aqueous CMC solutions having varied concentrations to determine a ratio in amount of CMC that remained unadsorbed and suspended in the slurry to CMC that was added. From the results, a percentage adsorption of CMC to graphite was determined. The results are shown in the following Table 1 in which 90 degree peel strength measurements are also shown.

TABLE 1

| | Solids | Surface | 90 Degree |
|---|---|---|---|
| Type of Negative | Concentration | Coverage | Peel Strength |
| Electrode | at Kneading | of CMC | [mN] |
| Negative Electrode 1 of | 0.45 | 64% | 103 |
| Preliminary Experiment | | | |
| Negative Electrode 2 of | 0.5 | 68% | 106 |
| Preliminary Experiment | | | |
| Negative Electrode 3 of | 0.55 | 81% | 121 |
| Preliminary Experiment | | | |
| Negative Electrode 4 of | 0.6 | 83% | 122 |
| Preliminary Experiment | | | |

As can be seen from the results shown in Table 1, the higher the solids concentration at the time of kneading, the higher the percentage adsorption of CMC. The 90 degree peel strength also increases correspondingly. These demonstrate that if the enhanced bond strength between the current collector and the mix layer is to be obtained, it is preferable that the solids concentration at the time of kneading is increased.

The percentage adsorption of CMC showed a trend of increasing with the solids concentration of the slurry when the solids concentration was relatively low. However, when the solids concentration of the slurry was high, the percentage adsorption of CMC showed only a sluggish increase even if the solids concentration of the slurry was increased. This is believed due to the low adsorbability of CMC, although the effect of water contained in the slurry can not be disregarded. Presumably, this low adsorbability prevents CMC from adsorbing over an entire surface of a graphite particle so that the graphite particle leaves a surface area unadsorbed by CMC. The use of CMC and PVP in combination, in accordance with the present invention, is presumed to allow PVP to adsorb onto the surface area left unadsorbed by CMC and thereby further increase the bond strength between the current collector and the mix layer.

In the preparation of the negative electrode-forming slurry, the timing for addition of CMC and PVP is not particularly specified. CMC and PVP may be added simultaneously, for example. Alternatively, either one of them may be added ahead and kneaded with the negative active material before the other is added. However, PVP is more adsorbable to the negative active material than CMC. From the viewpoints of allowing CMC to adsorb onto the negative active material effectively and increasing the dispersion stability of the negative active material in the mix layer, CMC is preferably added either simultaneously with or prior to addition of PVP. More preferably, CMC is added before PVP.

### EXAMPLE 1

### Fabrication of Positive Electrode

Using NMP (N-methyl-2-pyrrolidone) as a diluting solvent, lithium cobaltate as a positive active material, acethylene black as a carbon conductor and PVDF as a binder at a 95:2.5:2.5 ratio by weight were mixed in a kneader (HIVIS MIX, manufactured by Primix Corp.) to obtain a positive electrode-forming slurry. This positive electrode-forming slurry was coated on opposite sides of an aluminum foil, dried and then rolled to a packing density of 3.60 g/cc to complete a positive electrode.

### Fabrication of Negative Electrode

Using a mixer (ROBOMIX, manufactured by Primix Corp.), CMC (product of Daicel Chemical Industries, Ltd., product designation: 1380 (degree of etherification: 1.0-1.5)) was dissolved in deionized water to obtain a 1.0 weight % aqueous CMC solution.

Using a mixer (ROBOMIX, manufactured by Primix Corp.), PVP (product of Dai-ichi Kogyo Seiyaku Co., Ltd., product name “PITZCOL K-90”) was dissolved in deionized water to obtain a 1.0 weight % aqueous PVP solution. While the K value (catalogue value) of PVP (product of Dai-ichi Kogyo Seiyaku Co., Ltd., product name “PITZCOL K-90”) was listed as being 88-103, measurement of PVP (product of Dai-ichi Kogyo Seiyaku Co., Ltd., product name “PITZCOL K-90”) actually used in this Example revealed the K value of 95.

The above-obtained aqueous CMC solution was added to artificial graphite (mean particle diameter: 21 μm, surface area: 4.0 m²/g) so that the active material concentration was 60% by weight. Using a kneader (HIVIS MIX, manufactured by Primix Corp.), they were mixed at a rotational speed of 90 rpm for 60 minutes. Thereafter, the aqueous CMC solution was further added such that the ratio by weight of artificial graphite to CMC was brought to 98:0.8, followed by mixing at a rotational speed of 90 rpm for 20minutes. Subsequently, the above-obtained aqueous PVP solution was added such that the ratio by weight of artificial graphite to CMC to PVP was brought to 98:0.8:0.2, followed by mixing at a rotational speed of 90 rpm for 20 minutes. Then, SBR (solids concentration: 50% by weight) was introduced in the kneader such that the ratio by weight of artificial graphite to (CMC+PVP) to SBR was brought to 98:1:1, followed by mixing at a rotational speed of 40 rpm for 45 minutes. Subsequently, deionized water was further added to adjust a viscosity of the slurry to 1.0 Pa·s (25° C.), resulting in the preparation of a negative electrode-forming slurry.

Next, the negative electrode-forming slurry was coated on opposite sides of a copper foil to a target coating weight of 204 mg/10 cm², dried and then rolled to a packing density of 1.60 g/cc to obtain a negative electrode t1 of the present invention. A proportion in capacity of the facing positive and negative electrodes was adjusted to 1.10 so that the negative electrode is rendered capacity-rich.

A coating weight of the mix layer was determined by weighing a 50 mm×20 mm electrode cut out from the negative electrode t1 of the present invention using an even balance, weighing a 50 mm×20 mm copper foil cut out from the same copper foil as used in the fabrication of the negative electrode t1 of the present invention, and then calculating the coating weight by subtracting the weight of the copper foil from the measured weight of the negative electrode.

Evaluation of coatability was made by visual observation in accordance with the following evaluation standard.

◯: Neither uncoated portions nor streaks are observed on a coating surface.

Δ: Streaks are observed while no appreciable uncoated portions are observed on a coating surface.

x: Uncoated portions are observed on a coating surface.

The measurement result of the coating weight as well as the evaluation result of coatability are listed in Tables 2-4.

### Preparation of Nonaqueous Electrolyte

Lithium hexafluorophosphate (LiPF₆) was dissolved and mixed in a mixed solution containing EC and DEC at a 3:7 ratio by volume so that its concentration was brought to 1 mol/liter, thereby obtaining a nonaqueous electrolyte.

### Assembly of Battery

A lead terminal was attached to each of the above-obtained positive and negative electrodes which were then spirally wound with a polyethylene separator between them and pressed into a flat shape to fabricate an electrode assembly. This electrode assembly was inserted into an outer casing made of an aluminum laminate. Further, the above-prepared nonaqueous electrolyte was injected into the outer casing which was then sealed to obtain a battery T1 of the present invention.

In the assembly of the battery, a standard end-of-charge voltage was set at 4.2 V and a capacity at 650 mAh.

### EXAMPLE 2

The procedure of Example 1 was followed, with the exception that the proportion by weight of PVP and CMC in the negative electrode-forming slurry was changed to PVP/CMC=4/6, to fabricate a negative electrode of the present invention which was designated as t2. The procedure of Example 1 was followed, except using this negative electrode t2 of the present invention, to fabricate a battery of the present invention which was designated as T2.

### EXAMPLE 3

A 1.0 wt. % aqueous CMC solution and a 1.0 wt. % aqueous PVP solution were prepared in the same manner as in Example 1. They were blended such that the ratio by weight of CMC to PVP was brought to 8:2, thereby preparing a mixed CMC/PVP aqueous solution.

Subsequently, the mixed CMC/PVP aqueous solution was added to artificial graphite (mean particle diameter: 21 μm, surface area: 4.0 m²/g) such that a concentration of the active material was 60% by weight, followed by kneading at a rotational speed of 90 rpm for 60 minutes using a kneader (HIVIS MIX, manufactured by Primix Corp.). Thereafter, the mixed CMC/PVP aqueous solution was further added such that the ratio by weight of artificial graphite to (CMC+PVP) was brought to 98:1, followed by kneading at a rotational speed of 90 rpm for 20 minutes. Then, SBR (solids concentration: 50% by weight) was added to the kneader such that the ratio by weight of artificial graphite to (CMC+PVP) to SBR was brought to 98:1:1, followed by mixing at a rotational speed of 40 rpm for 45 minutes. Subsequently, deionized water was further added to adjust a viscosity of the slurry to 1.0 Pa·s (25° C.), resulting in the preparation of a negative electrode-forming slurry.

The procedure of Example 1 was followed, except using the above-prepared negative electrode-forming slurry, to fabricate a negative electrode of the present invention which was designated as t3.

### EXAMPLE 4

The procedure of Example 1 was followed, with the exception that the proportion by weight of PVP and CMC in the negative electrode-forming slurry was changed to PVP/CMC=1/9, to fabricate a negative electrode of the present invention which was designated as t4.

### EXAMPLE 5

The procedure of Example 1 was followed, with the exception that the proportion by weight of PVP and CMC in the negative electrode-forming slurry was changed to PVP/CMC=3/7, to fabricate a negative electrode of the present invention which was designated as t5.

### EXAMPLE 6

The procedure of Example 1 was followed, except substituting PVP (product of Dai-ichi Kogyo Seiyaku Co., Ltd., product name “PITZCOL K-80”, K value: 76-86 (catalogue value), 85 (measured value)) for PVP (product of Dai-ichi Kogyo Seiyaku Co., Ltd., product name “PITZCOL K-90”, K value: 88-103 (catalogue value), 95 (measured value)), to prepare a negative electrode-forming slurry. The procedure of Example 1 was followed, except using this negative electrode-forming slurry, to fabricate a negative electrode of the present invention which was designated as t6.

### EXAMPLE 7

The procedure of Example 1 was followed, except substituting PVP (product of Dai-ichi Kogyo Seiyaku Co., Ltd., product name “PITZCOL K-50”, K value: 47-55 (catalogue value), 50 (measured value)) for PVP (product of Dai-ichi Kogyo Seiyaku Co., Ltd., product name “PITZCOL K-90”, K value: 88-103 (catalogue value), 95 (measured value)), to prepare a negative electrode-forming slurry. The procedure of Example 1 was followed, except using this negative electrode-forming slurry, to fabricate a negative electrode of the present invention which was designated as t7.

### COMPARATIVE EXAMPLE 1

The procedure of Example 1 was followed, with the exception that PVP was excluded from the negative electrode-forming slurry and the proportion by weight of artificial graphite, CMC and SBR therein was changed to artificial graphite: CMC:SBR=98:1:1, to prepare a negative electrode-forming slurry. The procedure of Example 1 was followed, except using this negative electrode-forming slurry, to fabricate a comparative negative electrode which was designated as r1. The procedure of Example 1 was further followed, except using the comparative negative electrode r1, to fabricate a comparative battery which was designated as R1.

### COMPARATIVE EXAMPLE 2

The procedure of Example 1 was followed, with the exception that CMC was excluded from the negative electrode-forming slurry and the proportion by weight of artificial graphite, PVP and SBR therein was changed to artificial graphite: PVP:SBR=98:1:1, to prepare a negative electrode-forming slurry. The procedure of Example 1 was followed, except using this negative electrode-forming slurry, to fabricate a comparative negative electrode which was designated as r2.

### COMPARATIVE EXAMPLE 3

The procedure of Comparative Example 2 was followed, except substituting PVP (product of Dai-ichi Kogyo Seiyaku Co., Ltd., product name “PITZCOL K-30”, K value: 27-33 (catalogue value), 29 (measured value)) for PVP (product of Dai-ichi Kogyo Seiyaku Co., Ltd., product name “PITZCOL K-90”, K value: 88-103 (catalogue value), 95 (measured value)), to prepare a negative electrode-forming slurry. The procedure of Example 1 was followed, except using this negative electrode-forming slurry, to fabricate a comparative negative electrode which was designated as r3.

### COMPARATIVE EXAMPLE 4

The procedure of Example 1 was followed, except substituting PVP (product of Dai-ichi Kogyo Seiyaku Co., Ltd., product name “PITZCOL K-30”, K value: 27-33 (catalogue value), 29 (measured value)) for PVP (product of Dai-ichi Kogyo Seiyaku Co., Ltd., product name “PITZCOL K-90”, K value: 88-103 (catalogue value), 95 (measured value)), to prepare a negative electrode-forming slurry. The procedure of Example 1 was further followed, except using this negative electrode-forming slurry, to fabricate a comparative negative electrode which was designated as r4.

### COMPARATIVE EXAMPLE 5

The procedure of Example 1 was followed, with the exception that the proportion by weight of CMC and PVP in the negative electrode-forming slurry was changed to CMC:PVP=4:6, to prepare a negative electrode-forming slurry. The procedure of Example 1 was further followed, except using this negative electrode-forming slurry, to fabricate a comparative negative electrode which was designated as r5.

### COMPARATIVE EXAMPLE 6

The procedure of Example 1 was followed, except substituting PVP (product of Dai-ichi Kogyo Seiyaku Co., Ltd., product name “PITZCOL K-120L”, K value: 113-126 (catalogue value), 116 (measured value)) for PVP (product of Dai-ichi Kogyo Seiyaku Co., Ltd., product name “PITZCOL K-90”, K value: 88-103 (catalogue value), 95 (measured value)), to prepare a negative electrode-forming slurry. The procedure of Example 1 was further followed, except using this negative electrode-forming slurry to fabricate a comparative negative electrode which was designated as r6.

### Evaluation of Bond Strength Between Current Collector And Mix Layer In Negative Electrode

Bond strength between a current collector and a mix layer was evaluated by a 90 degree peel testing method for the negative electrodes t1-t7 of the present invention and the comparative negative electrodes r1-r6. Specifically, each negative electrode was first adhered onto a 120 mm×30 mm acrylic plate using a 70 mm×20 mm both-sided tape (“NICETACK NW-20” manufactured by Nichiban Co., Ltd.). One end of the adhered negative electrode was pulled 55 mm upward at a 90 degree angle relative to a surface of the mix layer at a constant speed (50 mm/min) using small-scale table testing instruments (“FGS-TV” and “FGP-5”) manufactured by Nidec-Shimpo Corporation to measure peel strength. This peel strength measurement was repeated three times and an average value of the three measurement results was reported as the 90 degree peel strength. The results are shown in the following Tables 2-4. In the following Table 3, the results are shown for the negative electrodes t4, t1, t5 and t2 and the comparative negative electrodes r5 and r1 which differ from each other only by the proportion by weight of PVP and CMC (PVP/CMC). In Table 4, the results are shown for the negative electrodes t1, t6 and t7 and the comparative negative electrodes r6 and r4 which differ from each other only by the type of the PVP used.

TABLE 2

| | PVP/CMC | | | 90 Degree |
|---|---|---|---|---|
| Type of Negative | Weight | K | Coatability | Peel Strength |
| Electrode | Ratio | Value | Coating Weight | [mN] |
| Present Negative | 2/8 | 95 | ∘ | 254 |
| Electrode t1 | | | 204 mg/10 cm² | |
| Present Negative | 4/6 | 95 | ∘ | 277 |
| Electrode t2 | | | 204 mg/10 cm² | |
| Present Negative | 2/8 | 95 | ∘ | 183 |
| Electrode t3 | (PVP and CMC | | 204 mg/10 cm² | |
| | added | | | |
| | simultaneously) | | | |
| Comp. Negative | 0/10 | — | ∘ | 122 |
| Electrode r1 | | | 204 mg/10 cm² | |
| Comp. Negative | 10/0 | 95 | x | 40 |
| Electrode r2 | | | 103 mg/10 cm² | |
| Comp. Negative | 10/0 | 29 | x | 43 |
| Electrode r3 | | | 98 mg/10 cm² | |
| Comp. Negative | 2/8 | 29 | Δ | 95 |
| Electrode r4 | | | 160 mg/10 cm² | |
| Comp. Negative | 6/4 | 95 | x | 115 |
| Electrode r5 | | | 152 mg/10 cm² | |

TABLE 3

| | PVP/CMC | | | 90 Degree |
|---|---|---|---|---|
| Type of Negative | Weight | K | Coatability | Peel Strength |
| Electrode | Ratio | Value | Coating Weight | [mN] |
| Present Negative | 1/9 | 95 | ∘ | 202 |
| Electrode t4 | | | 204 mg/10 cm² | |
| Present Negative | 2/8 | 95 | ∘ | 254 |
| Electrode t1 | | | 204 mg/10 cm² | |
| Present Negative | 3/7 | 95 | ∘ | 259 |
| Electrode t5 | | | 204 mg/10 cm² | |
| Present Negative | 4/6 | 95 | ∘ | 277 |
| Electrode t2 | | | 204 mg/10 cm² | |
| Comp. Negative | 6/4 | 95 | x | 115 |
| Electrode r5 | | | 152 mg/10 cm² | |
| Comp. Negative | 0/10 | — | ∘ | 122 |
| Electrode r1 | | | 204 mg/10 cm² | |

TABLE 4

| | PVP/CMC | | | 90 Degree |
|---|---|---|---|---|
| Type of Negative | Weight | K | Coatability | Peel Strength |
| Electrode | Ratio | Value | Coating Weight | [mN] |
| Comp. Negative | 2/8 | 116 | x | 151 |
| Electrode r6 | | | 180 mg/10 cm² | |
| Present Negative | 2/8 | 95 | ∘ | 254 |
| Electrode t1 | | | 204 mg/10 cm² | |
| Present Negative | 2/8 | 85 | ∘ | 224 |
| Electrode t6 | | | 204 mg/10 cm² | |
| Present Negative | 2/8 | 50 | ∘ | 135 |
| Electrode t7 | | | 204 mg/10 cm² | |
| Comp. Negative | 2/8 | 29 | x | 95 |
| Electrode r4 | | | 160 mg/10 cm² | |

As shown in Tables 2-4, the negative electrodes t1-t7 of this invention, which used the negative electrode-forming slurry having the K value in the range of 50-95 and the higher CMC content than the PVP content, exhibited a high coating weight of not less than 200 mg/10 cm², superior coatability and a high 90 degree peel strength of not less than 130 mN.

In contrast, the comparative negative electrodes r2 and r3, which used the negative electrode-forming slurry excluding CMC and containing PVP as a sole dispersant, exhibited a low coating weight of about 100 mg/10 cm² due to the low viscosity of the negative electrode-forming slurry, poor coatability and a low 90 degree peel strength of not greater than 50 mN. Additional experiments for evaluation of coatability were conducted by varying the PVP content by weight of the PVP aqueous solution. However, similar to the results for the comparative negative electrodes r2 and r3, in all cases where CMC was excluded and PVP was used as a sole dispersant, the high coating weight and coatability results comparable to those of the negative electrodes t1-t3 of the present invention were not obtained. These results are believed due to the high adsorbability of PVP to graphite, as described earlier.

Also, the comparative negative electrode r1 exhibited a high coating weight of 204 mg/10 cm² but a deteriorated 90 degree peel strength of 122 mN, as a result of the use of the slurry which excluded PVP and used CMC as a sole dispersant.

As shown in the above Table 3, the improved 90 degree peel strength was obtained in conjunction with the increased ratio by weight of PVP to CMC (PVP/CMC). Only the reduced 90 degree peel strength results were obtained for the comparative negative electrodes r5 and r1. This demonstrates that the enhanced 90 degree peel strength of exceeding 200 mN is obtained if the ratio by weight of PVP to CMC is kept within the range between 1/9 and 4/6.

As also shown in the above Table 4, the superior coatability, high coating weight and enhanced 90 degree peel strength were obtained for the negative electrodes t1, t6 and t7 of the present invention with the K values of PVP within the range of 50-95. On the other hand, the poor coatability and low coating weight of 180 mg/10 cm² were obtained for the comparative negative electrode r6 with the K value of PVP of 116. These results show that if the K value of PVP exceeds 112, coatability deteriorates and the coating weight decreases.

The poor coatability, low coating weight of 160 mg/10 cm² and deteriorated 90 degree peel strength of 95 mN were obtained for the comparative negative electrode r4 with the K value of PVP of 29. These results show that if the K value of PVP falls below 34, coatability deteriorates, the coating weight decreases and bond strength also deteriorates.

As also shown in Table 2, the negative electrodes t1 and t2 of the present invention made through sequential addition of CMC and PVP to graphite exhibit improved bond strength between the current collector and the mix layer, compared to the negative electrode t3 of the present invention made through simultaneous addition of CMC and PVP to graphite, demonstrating that CMC is preferably added to graphite before PVP.

### Evaluation of Battery Performance

The batteries T1 and T2 of the present invention and the comparative battery R1 were evaluated for battery performance at 25° C. according to the following tests wherein a 10 minute pause was provided between a charge test and a discharge test.

### Charge Test

Each battery was charged at a constant current of 1 C (650 mA) to a battery voltage of 4.2 V and further charged at a constant voltage of 4.2 V to a current of 1/20 C (32.5 mA).

### Discharge Test

The battery was discharged at a constant current of 1 C (650 mA) or 3 C to a battery voltage of 2.75 V.

From the discharge capacity values measured at 3 C and 1 C in the above charge-discharge test, (discharge capacity at 3 C)/(discharge capacity at 1 C) was calculated. The results are shown in the following Table 5.

TABLE 5

| | PVP/CMC | | 3C/1C |
|---|---|---|---|
| Type of Battery | Weight Ratio | K Value | Efficiency |
| Present Battery T1 | 2/8 | 95 | 34% |
| Present Battery T2 | 4/6 | 95 | 36% |
| Comp. Battery R1 | 0/10 | — | 35% |

As shown in Table 5, the batteries T1 and T2 of the present invention exhibited a charge-discharge performance that is comparable to that of the comparative battery R1 using CMC as a sole dispersant for the negative electrode-forming slurry. These results confirmed that a high charge-discharge performance was obtained even for the case where CMC and PVP were used in combination as a dispersant for the negative electrode-forming slurry.

1. A negative electrode for a nonaqueous electrolyte secondary battery which includes a current collector and a mix layer provided on the current collector, wherein said mix layer contains polyvinyl pyrrolidone having a K value in the range of 34-112, carboxymethylcellulose, a latex binder and a negative active material, said carboxymethylcellulose being contained in a higher concentration by weight than said polyvinyl pyrrolidone, and wherein said K value is given by the following equation:
K=(1.5 log η−1)/(0.15+0.003 c)+{300 c log η+(c+1.5 c log η)²}^{1/2}/(0.15 c+0.003 c²)
where,
η is a relative viscosity at 25° C. of an aqueous polyvinyl pyrrolidone solution to water; and
c is a weight concentration of polyvinyl pyrrolidone in the aqueous polyvinyl pyrrolidone solution.

2. The negative electrode for a nonaqueous electrolyte secondary battery as recited in claim 1, wherein a ratio by weight of said polyvinyl pyrrolidone to said carboxymethylcellulose in said mix layer is greater than 0/10 but not greater than 4/6.

3. The negative electrode for a nonaqueous electrolyte secondary battery as recited in claim 1, wherein the K value of said polyvinyl pyrrolidone is in the range of 47-103.

4. The negative electrode for a nonaqueous electrolyte secondary battery as recited in claim 1, wherein said negative active material is a carbon material.

5. The negative electrode for a nonaqueous electrolyte secondary battery as recited in claim 4, wherein said carbon material is graphite.

6. The negative electrode for a nonaqueous electrolyte secondary battery as recited in claim 1, wherein said latex binder is styrene-butadiene rubber.

7. The negative electrode for a nonaqueous electrolyte secondary battery as recited in claim 1, wherein a total amount of said carboxymethylcellulose and said polyvinyl pyrrolidone contained in said mix layer is in the range of 0.2-2.0% by weight.

8. The negative electrode for a nonaqueous electrolyte secondary battery as recited in claim 2, wherein a total amount of said carboxymethylcellulose and said polyvinyl pyrrolidone contained in said mix layer is in the range of 0.2-2.0% by weight.

9. The negative electrode for a nonaqueous electrolyte secondary battery as recited in claim 1, wherein the amount of said latex binder contained in said mix layer is in the range of 0.5-2.0% by weight.

10. A nonaqueous electrolyte secondary battery including the negative electrode for a nonaqueous electrolyte secondary battery as recited in claim 1, a positive electrode and a nonaqueous electrolyte.

11. A method for fabrication of the negative electrode recited in claim 1, comprising the steps of:
preparing an aqueous slurry which contains said polyvinyl pyrrolidone having the K value given by said equation in the range of 34-112, and said carboxymethylcellulose, said latex binder and said negative active material, said carboxymethylcellulose being contained in a higher weight concentration than said polyvinyl pyrrolidone; and
forming said mix layer by coating said aqueous slurry onto said current collector and drying the aqueous slurry.

12. The method of claim 11, wherein in the step of preparing said aqueous slurry, said carboxymethylcellulose is added to said negative active material before said polyvinyl pyrrolidone.
